(19) United States
(12) Patent Application Publication
(10) Pub. No.: US 2025/0050695 A1
(43) Pub. Date: Feb. 13, 2025

(54) VEHICLE TRAILER HITCH SYSTEMS WITH INTEGRATED FEATURES FOR ADDED FUNCTIONALITY

(71) Applicant: FORD GLOBAL TECHNOLOGIES, LLC, Dearborn, MI (US)

(72) Inventors: Stuart C. SALTER, White Lake, MI (US); Adrian AGUIRRE, Bloomfield Hills, MI (US); Andre KUNYNETZ, LaSalle (CA); David J. PFEIFFER, Canton, MI (US); Brendan DIAMOND, Grosse Pointe, MI (US)

(21) Appl. No.: 18/448,214

(22) Filed: Aug. 11, 2023

(51) Int. Cl. B60D 1/52; B60D 1/58

(52) U.S. Cl. CPC B60D 1/52; B60D 1/58

(57) ABSTRACT

Vehicle trailer hitch systems may include integrated features for increasing the functionality of the vehicle. A bottle opener feature may be integrated as part of a hitch plate of the trailer hitch system. The integrated bottle opener feature is therefore conveniently packaged on the vehicle for use during outdoor social gatherings when the vehicle is stationary.

### TECHNICAL FIELD

This disclosure relates generally to motor vehicles, and more particularly to vehicle trailer hitch systems that are equipped with integrated features for providing added functionality.

### BACKGROUND

Vehicles can be utilized as social gathering spots during outdoor activities, such as camping and tailgating activities. Vehicle users typically must remember to carry various tools and convenience items on the vehicle, such as bottle openers.

### SUMMARY

A vehicle trailer hitch system according to an exemplary aspect of the present disclosure includes, among other things, a hitch receiver and a hitch plate mounted to the hitch receiver. The hitch plate includes a slot configured to establish both a trailer chain placement feature and a bottle opener feature within the hitch plate.

In a further non-limiting embodiment of the foregoing vehicle trailer hitch system, the hitch plate includes a first plate section, a second plate section, and a mid-section extending between the first plate section and the second plate section.

In a further non-limiting embodiment of either of the foregoing vehicle trailer hitch systems, the slot is formed through the first plate section or the second plate section.

In a further non-limiting embodiment of any of the foregoing vehicle trailer hitch systems, the first plate section or the second plate section includes a lower lip that bounds a first lateral edge of the slot and an upper lip that bounds a second lateral edge of the slot.

In a further non-limiting embodiment of any of the foregoing vehicle trailer hitch systems, the bottle opener feature is established by the lower lip and the upper lip.

In a further non-limiting embodiment of any of the foregoing vehicle trailer hitch systems, the lower lip or the upper lip establishes a fulcrum of the bottle opener feature, and the other of the lower lip or the upper lip is configured to engage a bottle cap of a bottle.

In a further non-limiting embodiment of any of the foregoing vehicle trailer hitch systems, the trailer chain placement feature is established by a first portion of the slot, and the bottle opener feature is established by a second, different portion of the slot.

In a further non-limiting embodiment of any of the foregoing vehicle trailer hitch systems, the first portion is a rearmost portion of the slot.

In a further non-limiting embodiment of any of the foregoing vehicle trailer hitch systems, a control module is programmed to command a lighting system to generate a lighting effect for illuminating at least a portion of the hitch plate.

In a further non-limiting embodiment of any of the foregoing vehicle trailer hitch systems, the control module is programmed to command the lighting system to generate the lighting effect in response to receiving a signal from a sensor system indicating that an authorized user is within a threshold distance of the vehicle trailer hitch system.

A vehicle according to another exemplary aspect of the present disclosure includes, among other things, a trailer hitch system including a hitch plate. The hitch plate includes an integrated bottle opener feature.

In a further non-limiting embodiment of the foregoing vehicle, the hitch plate includes a slot having a first lateral edge bounded by a lower lip and a second lateral edge bounded by an upper lip.

In a further non-limiting embodiment of either of the foregoing vehicles, the lower lip is vertically offset from the upper lip.

In a further non-limiting embodiment of any of the foregoing vehicles, the lower lip is laterally outward of the upper lip.

In a further non-limiting embodiment of any of the foregoing vehicles, the upper lip is laterally outward of the lower lip.

In a further non-limiting embodiment of any of the foregoing vehicles, the integrated bottle opener feature is established by the lower lip and the upper lip.

In a further non-limiting embodiment of any of the foregoing vehicles, the integrated bottle opener feature is configured such that the lower lip functions to engage a bottle cap of a bottle and the upper lip functions as a fulcrum for exerting a force for removing the bottle cap from the bottle.

In a further non-limiting embodiment of any of the foregoing vehicles, the hitch plate is mounted to a hitch receiver of the trailer hitch system.

In a further non-limiting embodiment of any of the foregoing vehicles, a control module is programmed to command a lighting system to generate a lighting effect for illuminating at least a portion of the hitch plate.

In a further non-limiting embodiment of any of the foregoing vehicles, the hitch plate establishes a trailer chain placement feature.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a rear perspective view of a motor vehicle equipped with a trailer hitch system.

FIG. 2 is a perspective view of a vehicle trailer hitch system.

FIG. 3 is a rear view of the trailer hitch system of FIG. 2.

FIG. 4 is a bottom view of the trailer hitch system of FIG. 2.

FIG. 5 illustrates an exemplary hitch plate of a vehicle trailer hitch system.

FIG. 6 illustrates another exemplary hitch plate of a vehicle trailer hitch system.

FIG. 7 is a block diagram illustrating exemplary illumination aspects of a vehicle trailer hitch system.

### DETAILED DESCRIPTION

This disclosure details vehicle trailer hitch systems that include integrated features for increasing the functionality of the vehicle. A bottle opener feature may be integrated as part of a hitch plate of the trailer hitch system. The integrated bottle opener feature is therefore conveniently packaged on the vehicle for use during outdoor social gatherings when the vehicle is stationary. These and other features of this disclosure are described in greater detail below.

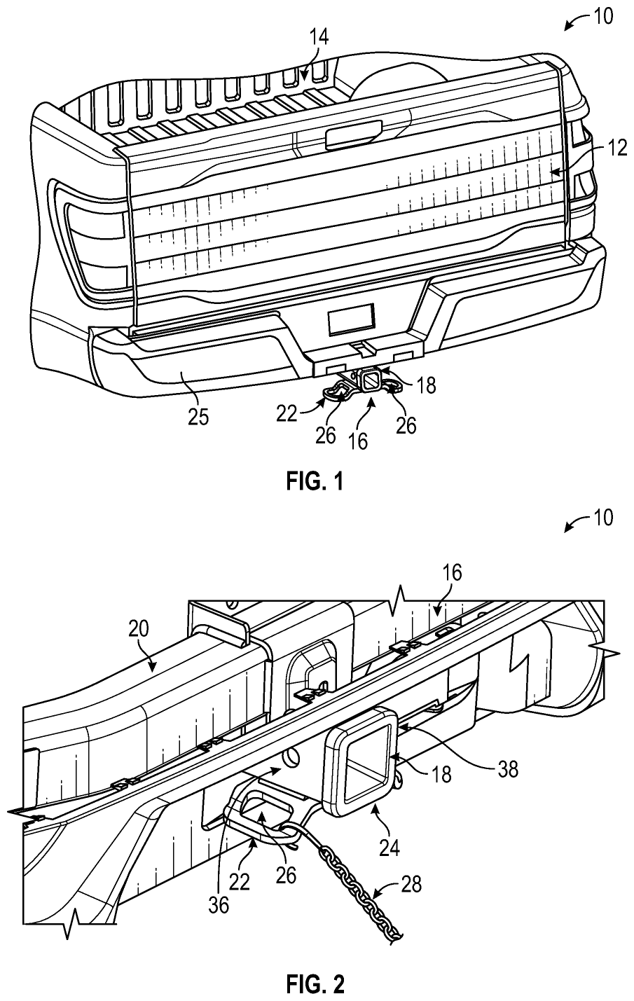

FIGS. 1 and 2 illustrate select portions of a motor vehicle 10 (hereinafter referred to as “the vehicle.”). The vehicle 10 may include a closure member 12 that can be moved between a closed position and an open position for accessing a cargo space 14 of the vehicle 10. In the illustrated embodiment, the closure member 12 is a tailgate, and the cargo space 14 is a cargo bed of a pickup truck. As would be appreciated by a person of ordinary skill in the art having the benefit of this disclosure, although a pickup truck with a cargo bed is specifically depicted and referenced herein, other vehicles having other types of cargo spaces could also benefit from the trailer hitch teachings of this disclosure. Moreover, the vehicle 10 could be a conventional, internal combustion engine powered vehicle, a traction battery powered electric or hybrid vehicle, an autonomous vehicle (i.e., a driverless vehicle), etc.

Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

The vehicle 10 may further include a trailer hitch system 16 for towing a trailer or some other structure behind the vehicle 10. The trailer hitch system 16 may include a hitch receiver 18 that is adapted to receive another trailer component (e.g., a hitch ball mount), such as for connecting a trailer to the vehicle 10, for example. The hitch receiver 18 may be mounted to or otherwise integrated with a beam 20 that extends in a cross-width direction of the vehicle 10. The beam 20 may be mounted to a vehicle static body structure of the vehicle 10 for supporting the trailer hitch system 16 relative to the vehicle 10. In some implementations, the beam 20 may at least partially support a bumper 25 of the vehicle 10.

A hitch plate 22 may be mounted (e.g., welded, bolted, etc.) to an underside 24 of the hitch receiver 18. The hitch plate 22 may include a pair of slots 26 (e.g., one located on each side of the hitch receiver 18). Each slot 26 may provide an attachment point for connecting a trailer chain 28 (see FIG. 2) for preventing a towed trailer from separating from the vehicle 10 during a towing event. Moreover, as discussed in greater detail below, additional functionality (e.g., a bottle opener feature) can be integrated as part of the hitch plate 22 of the trailer hitch system 16 in order to increase the functionality of the vehicle 10 and facilitate a more enjoyable user experience, such as when using the vehicle 10 as a social gathering spot during outdoor activities (e.g., camping, tailgating, etc.), for example.

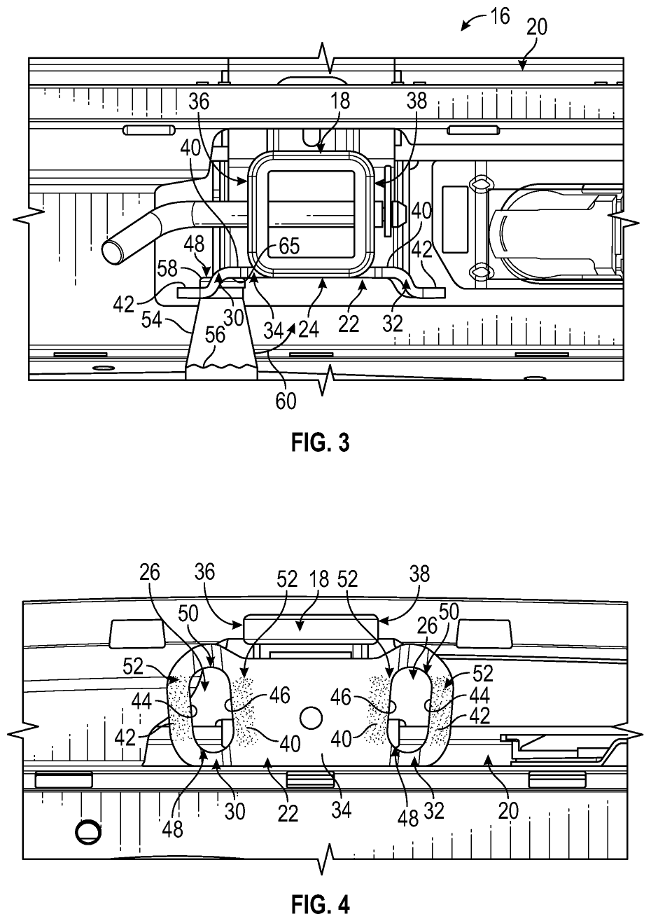

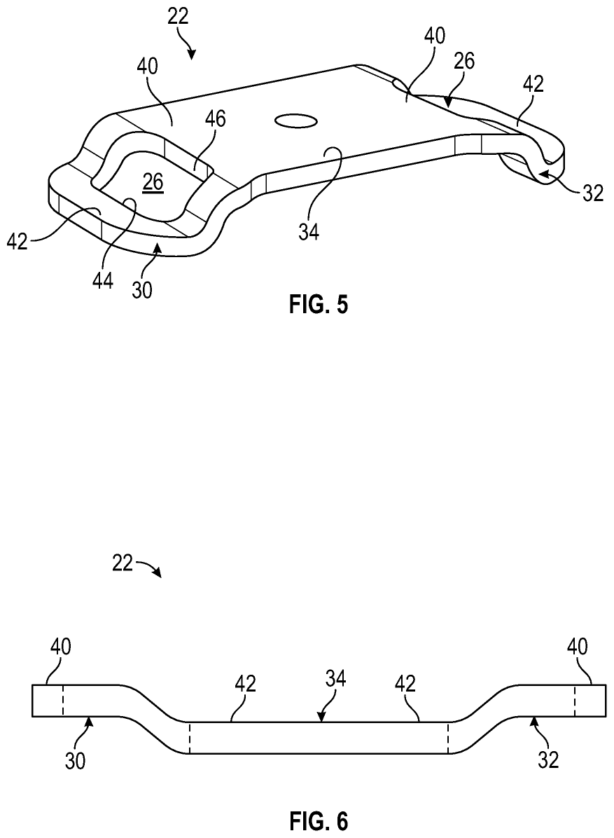

Referring now primarily to FIGS. 3, 4, and 5, the hitch plate 22 may include a first plate section 30 that extends outwardly of a first side 36 of the hitch receiver 18, a second plate section 32 that extends outwardly of a second side 38 of the hitch receiver 18, and a mid-section 34 that extends between the first plate section 30 and the second plate section 32. The mid-section 34 may be mounted (e.g., welded, bolted, etc.) directly to the underside 24 of the hitch receiver 18.

Each of the first plate section 30 and the second plate section 32 may include an upper lip 40 and a lower lip 42 that is vertically offset from the upper lip 40 such that the upper lip 40 and the lower lip 42 extend in different but substantially parallel planes. In an embodiment, the lower lip 42 is laterally outward of the upper lip 40 and is therefore located further from the mid-section 34 than the upper lip 40. However, in another embodiment, the hitch plate 22 could be configured such that the upper lip 40 is laterally outward of the lower lip 42 and is therefore located further from the mid-section 34 than the lower lip 42 (see, e.g., FIG. 6).

One of the slots 26 may be formed through each of the first plate section 30 and the second plate section 32 of the hitch plate 22. Each slot 26 may be an elongated opening that includes a first lateral edge 44 (e.g., a first long side) and a second lateral edge 46 (e.g., a second long side). The first lateral edge 44 may be bound by a portion of the lower lip 42, and the second lateral edge 46 may be bound by a portion of the upper lip 40.

The portion of the lower lip 42 that bounds the first lateral edge 44 of the slot 26 and the portion of the upper lip 40 that bounds the second lateral edge 46 of the slot 26 may cooperate to provide a bottle opener feature 48 (see FIG. 3) that is integrated as part of the hitch plate 22 of the trailer hitch system 16. For example, as further discussed below, the lower lip 42 may act as a tooth or raised lip that is configured to engage the underside of a bottle cap 58, and the upper lip 40 may act as a fulcrum across which a force may be exerted for removing the bottle cap 58 from a bottle 54. The bottle opener feature 48 therefore provides additional functionality to the hitch plate 22 beyond providing attachment points for receiving the trailer chains 28.

Each slot 26 may be partitioned to provide both the bottle opener feature 48 and a trailer chain placement feature 50 (best shown in FIG. 4). In this way, the bottle opener feature 48 may be utilized even when a trailer chain is attached to the slot 26. In an embodiment, the trailer chain placement feature 50 is localized at a rear-most section of the hitch plate 22 (relative to a normal orientation of the vehicle 10). The trailer chain placement feature 50 may therefore be located further away from the beam 20 of the trailer hitch system 16 compared to the bottle opener feature 48.

The hitch plate 22 may be constructed from a high strength steel. However, other materials are contemplated within the scope of this disclosure. In some implementations, portions of the hitch plate 22 (e.g., the lower lip 42 and/or the upper lip 40) may be coated with a protective coating 52 (shown schematically in FIG. 4). The protective coating 52 may be adapted for limiting wear and corrosion during the operable life of the hitch plate 22. The protective coating 52 may be a zinc-nickel alloy coating, and epoxy powder coating, or any other suitable protective coating. The protective coating 52 may optionally include long persistence phosphor that allows the hitch plate 22 to glow during nighttime conditions to better mark the locations of the bottle opener feature 48 and the trailer chain placement feature 50.

An exemplary use of the integrated bottle opener feature 48 for opening a bottle 54 that contains a beverage 56 is schematically illustrated in FIG. 3. Prior to opening, the beverage 56 is contained within the bottle 54 by a bottle cap 58. The bottle opener feature 48 may be used to conveniently remove the bottle cap 58 from the bottle 54 during stationary, non-moving conditions of the vehicle 10. The bottle opener feature 48 may be used during outdoor social gathering and eliminates the need for the user to remember to carry a separate bottle opener.

The bottle opener feature 48 may be used to remove the bottle cap 58 from the bottle 54 in the following exemplary manner. A user may first position the bottle 54 from underneath the hitch plate 22 such that the bottle cap 58 is at least partially received within one of the slots 26. The bottle 54 may be moved upwardly through the respective slot 26 until the bottle cap 58 can be received in abutting contact with the lower lip 42 of the hitch plate 22. The lower lip 42 positions the bottle cap 58 such that an inward swing path (shown schematically via arrow 60) is required to remove the bottle cap 58 from the bottle 54. In the illustrated embodiment, the inward swing path 60 extends in a direction toward the middle of the vehicle 10. However, other implementations are contemplated within the scope of this disclosure.

As the user moves the bottle 54 along the inward swing path 60, the bottle cap 58 is moved into firm engagement with a contact surface 65 of the upper lip 40, thereby applying an opening force for removing the bottle cap 58 from the bottle 54. The upper lip 40 may support and stabilize the bottle 54 during its movement along the inward swing path 60.

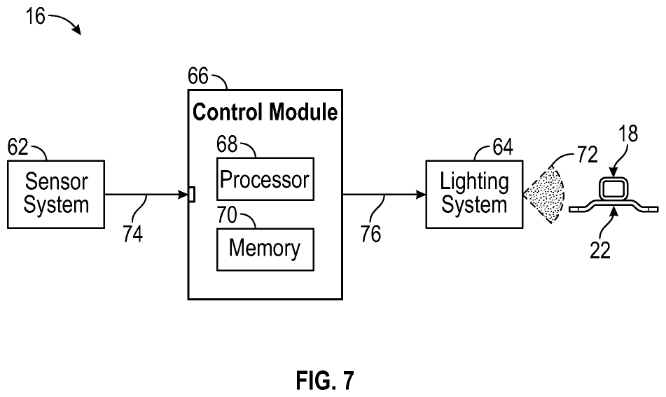

FIG. 7, with continued reference to FIGS. 1-6, is a block diagram for schematically illustrating additionally functionality of the trailer hitch system 16. The trailer hitch system 16 may include a sensor system 62, a lighting system 64, and a control module 66. In response to commands from the control module 66, the lighting system 64 may be configured to illuminate portions of the hitch plate 22 and/or the hitch receiver 18 when the sensor system 62 detects the presence of a user near the vehicle 10.

The sensor system 62 may include various sensors and other components (e.g., cameras) that are capable of monitoring the environment around the vehicle 10, such as for inferring when a user is within a threshold distance of the vehicle 10. The lighting system 64 may include one or more lamps capable of generating light near the hitch plate 22 and/or the hitch receiver 18. For example, the lighting system 64 could include one or more lamps associated with brake lights, license plate lights, etc.

The control module 66 may be equipped with executable instructions for interfacing with and commanding operation of various components of the lighting system 64. The control module 66 may include a processing unit 68 and non-transitory memory 70 for executing the various control strategies and modes of the lighting system 64. The processing unit 68 can be programmed to execute one or more programs stored in the memory 70. The program may be stored in the memory 70 as software code, for example. Each program stored in the memory 70 may include an ordered list of executable instructions for implementing logical functions associated with lighting system 64. The processing unit 68 can be a custom made or commercially available processor, a central processing unit (CPU), or generally any device for executing software instructions. The memory 70 can include any one or combination of volatile memory elements and/or nonvolatile memory elements.

The control module 66 may be programmed, in an embodiment, to command the lighting system 64 to project a lighting effect 72 for illuminating the hitch plate 22 and/or the hitch receiver 18 in response to receiving a signal 74 from the sensor system 62. The signal 74 may indicate that an authorized user has been detected or inferred within a threshold distance from the vehicle 10, thus indicating that use of the bottle opener feature 48 may be impending. In response to receiving the signal 74, the control module 66 may communicate a lighting effect command signal 76 to the lighting system 64 for producing the lighting effect 72. One or more lamps of the lighting system 64 may therefore be activated for illuminating the hitch plate 22 and/or the hitch receiver 18.

The trailer hitch systems of this disclosure include integrated bottle opener features that are packaged together with a hitch component of the trailer hitch system, thereby adding functionality to the trailer hitch system without requiring additional parts or complexity. The integrated bottle opener features are conveniently packaged near a cargo space of the vehicle and facilitate a more enjoyable usage and experience during outdoor social gatherings when the vehicle is stationary.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle trailer hitch system, comprising:
a hitch receiver; and
a hitch plate mounted to the hitch receiver,
wherein the hitch plate includes a slot configured to establish both a trailer chain placement feature and a bottle opener feature within the hitch plate.

2. The vehicle trailer hitch system as recited in claim 1, wherein the hitch plate includes a first plate section, a second plate section, and a mid-section extending between the first plate section and the second plate section.

3. The vehicle trailer hitch system as recited in claim 2, wherein the slot is formed through the first plate section or the second plate section.

4. The vehicle trailer hitch system as recited in claim 3, wherein the first plate section or the second plate section includes a lower lip that bounds a first lateral edge of the slot and an upper lip that bounds a second lateral edge of the slot.

5. The vehicle trailer hitch system as recited in claim 4, wherein the bottle opener feature is established by the lower lip and the upper lip.

6. The vehicle trailer hitch system as recited in claim 5, wherein the lower lip or the upper lip establishes a fulcrum of the bottle opener feature, and the other of the lower lip or the upper lip is configured to engage a bottle cap of a bottle.

7. The vehicle trailer hitch system as recited in claim 1, wherein the trailer chain placement feature is established by a first portion of the slot, and the bottle opener feature is established by a second, different portion of the slot.

8. The vehicle trailer hitch system as recited in claim 7, wherein the first portion is a rearmost portion of the slot.

9. The vehicle trailer hitch system as recited in claim 1, comprising a control module programmed to command a lighting system to generate a lighting effect for illuminating at least a portion of the hitch plate.

10. The vehicle trailer hitch system as recited in claim 9, wherein the control module is programmed to command the lighting system to generate the lighting effect in response to receiving a signal from a sensor system indicating that an authorized user is within a threshold distance of the vehicle trailer hitch system.

11. A vehicle, comprising:
a trailer hitch system including a hitch plate,
wherein the hitch plate includes an integrated bottle opener feature.

12. The vehicle as recited in claim 11, wherein the hitch plate includes a slot having a first lateral edge bounded by a lower lip and a second lateral edge bounded by an upper lip.

13. The vehicle as recited in claim 12, wherein the lower lip is vertically offset from the upper lip.

14. The vehicle as recited in claim 13, wherein the lower lip is laterally outward of the upper lip.

15. The vehicle as recited in claim 13, wherein the upper lip is laterally outward of the lower lip.

16. The vehicle as recited in claim 12, wherein the integrated bottle opener feature is established by the lower lip and the upper lip.

17. The vehicle as recited in claim 16, wherein the integrated bottle opener feature is configured such that the lower lip functions to engage a bottle cap of a bottle and the upper lip functions as a fulcrum for exerting a force for removing the bottle cap from the bottle.

18. The vehicle as recited in claim 11, wherein the hitch plate is mounted to a hitch receiver of the trailer hitch system.

19. The vehicle as recited in claim 11, comprising a control module programmed to command a lighting system to generate a lighting effect for illuminating at least a portion of the hitch plate.

20. The vehicle as recited in claim 11, wherein the hitch plate establishes a trailer chain placement feature.
